(19) United States
(12) Patent Application Publication
(10) Pub. No.: US 2014/0101027 A1
(43) Pub. Date: Apr. 10, 2014

(54) BUCKET RATE AGGREGATION OF FINANCIAL LENDING APPLICATIONS

(71) Applicants: Rajive Kumar JAIN, Oakville (CA); Ketan BHALLA, Ottawa (CA)

(72) Inventors: Rajive Kumar JAIN, Oakville (CA); Ketan BHALLA, Ottawa (CA)

(21) Appl. No.: 14/046,905

(22) Filed: Oct. 4, 2013

Related U.S. Application Data
(60) Provisional application No. 61/709,931, filed on Oct. 4, 2012.

(51) Int. Cl. G06Q 40/02

(52) U.S. Cl. CPC G06Q 40/025
USPC 705/38

(57) ABSTRACT

Pools of money or loanable funds are created. The pool is assigned certain attributes. People, companies or entities are allowed to apply to the pools of loanable funds as loan applicants. The loan applications are aggregated and forwarded to a lender or creditor or on behalf of the creator of a pool to a lender. The creator can be a lending entity, a company or a person. The pools can be given a combination of characteristics that are considered the current and normal method of expressing loans and credit applications to the public as well as lenders and creditors.

### CROSS REFERENCE TO RELATED APPLICATION

This application claims priority of U.S. Provisional Application No. 61/709,931, filed Oct. 4, 2012, the contents of which are hereby incorporated in its entirety.

### FIELD OF THE INVENTION

The invention relates generally to financial computer processes, and more specifically, to aggregating electronic mortgage applications for group rates.

### BACKGROUND

Currently, mortgage applicants work individually with different mortgage brokers to obtain financing for homes, autos, construction, and other purchases. To do so, the applicant fills out an application with a particular lender, and is in turn quoted a rate based on applicant qualifications. The broker is paid a commission for successfully financed applications.

However, individual applicants do not bring a large scale of customers to the lenders and creditors. The terms of each financing is individually-customized, thereby making the process complex for the lender. Furthermore, the broker commission raises the cost of loans.

Therefore, what is needed is a technique that reduces or eliminates mortgage brokers and associated costs, while reducing the complexity of custom financing by aggregating mortgage applicants into groups directly marketed to or by lenders.

### SUMMARY

To meet the above-described needs, methods, computer program products, and systems for aggregating loan applicants into groups for group-based financing.

In one embodiment, pools of money or loanable funds are created. The pool is assigned certain attributes. People, companies or entities are allowed to apply to the pools of loanable funds as loan applicants. The loan applications are aggregated (or pooled, or combined) and forwarded to a lender or creditor or on behalf of the creator of a pool to a lender. The creator can be a lending entity, a company or a person. The pools can be given a combination of characteristics that are considered the current and normal method of expressing loans and credit applications to the public as well as lenders and creditors.

Advantageously, group-based loans reduces the complexity of loan products and allows lenders to directly market to applicants, and eliminating the cost of brokers.

### BRIEF DESCRIPTION OF THE DRAWINGS

In the following drawings, like reference numbers are used to refer to like elements. Although the following figures depict various examples of the invention, the invention is not limited to the examples depicted in the figures.

FIGS. 1A-B are flow charts illustrating a method for aggregating loan applications in a user created pool, according to one embodiment.

FIGS. 2A-C are flow charts illustrating a method for aggregating loan applications in a lender created pool, according to one embodiment.

FIG. 3 is a block diagram illustrating creation of a pool, according to one embodiment.

FIG. 4 is a block diagram illustrating viewing and applying to pools, according to one embodiment.

FIG. 5 is a block diagram illustrating electronic messages sent by the system in response to new applications, according to one embodiment.

FIG. 6 is a block diagram illustrating electronic messages sent by the system concerning a current status of pool conditions, according to an embodiment.

FIG. 7 is a block diagram illustrating electronic messages sent by the system concerning an approaching pool condition, according to an embodiment.

FIG. 8 is a block diagram illustrating electronic messages sent by the system upon meeting the pool conditions, according to one embodiment.

FIG. 9 is a block diagram illustrating distribution of pool information, according to one embodiment.

FIG. 10 is a block diagram illustrating electronic messages sent by the system concerning status of loan applications, according to one embodiment.

FIG. 11 is a block diagram illustrating submission of a pool, according to one embodiment.

FIG. 12 is a schematic diagram illustrating a home page on a web site for aggregating loan applications, according to one embodiment.

FIG. 13 is a schematic diagram illustrating currently available pools on a web site for aggregating loan applications, according to one embodiment.

FIG. 14 is a schematic diagram illustrating pool creation on a web site for aggregating loan applications, according to one embodiment.

FIG. 15 is a schematic diagram illustrating a pool application form on a web site for aggregating loan applications, according to one embodiment.

FIG. 16 is a schematic diagram illustrating a list of pool applications on a web site for aggregating loan applications, according to one embodiment.

FIG. 17 is a schematic diagram illustrating a list of applications for a pool on a web site for aggregating loan applications, according to one embodiment.

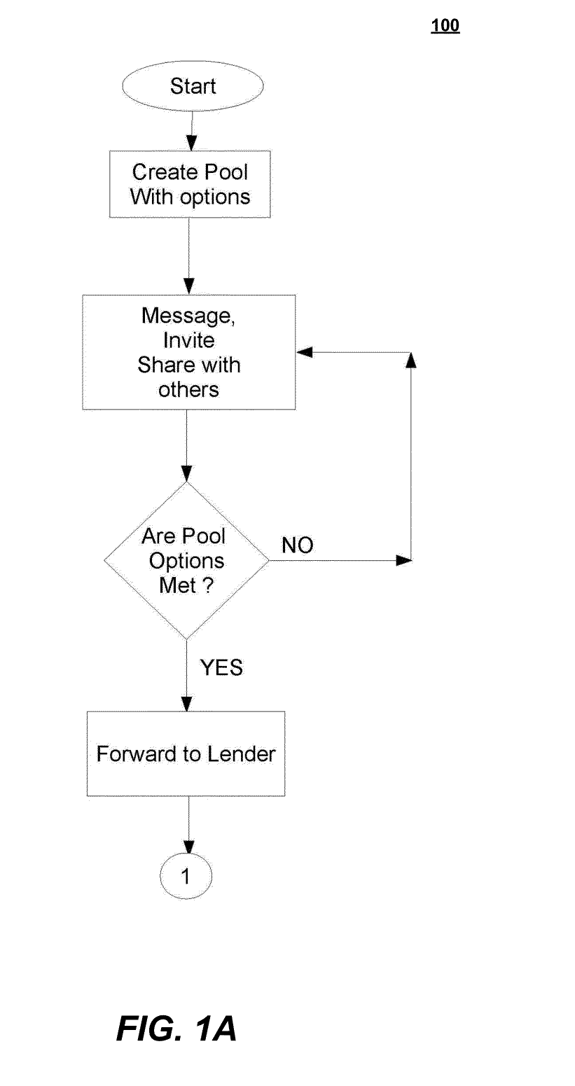

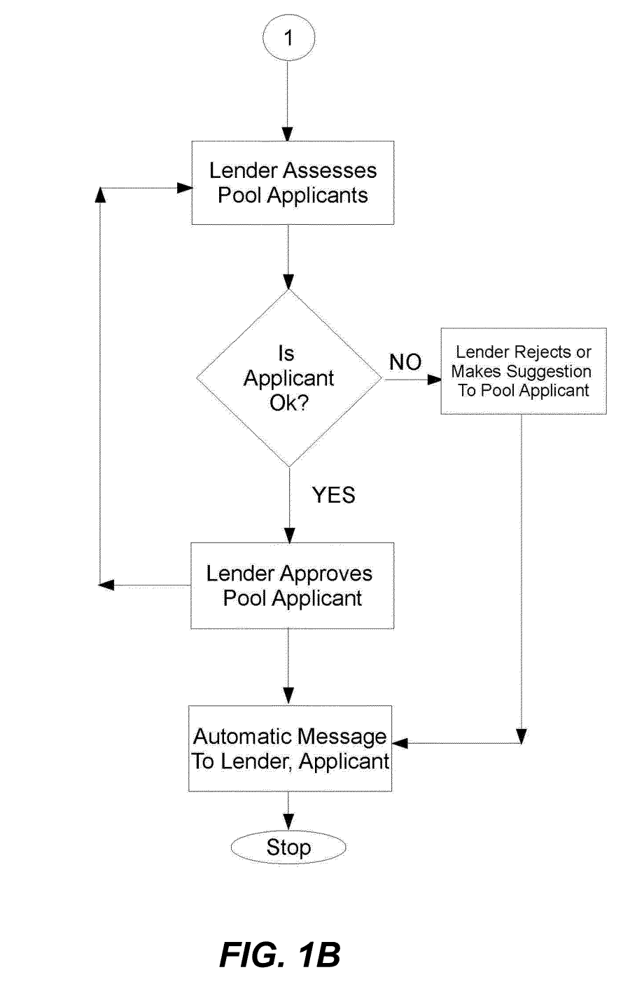

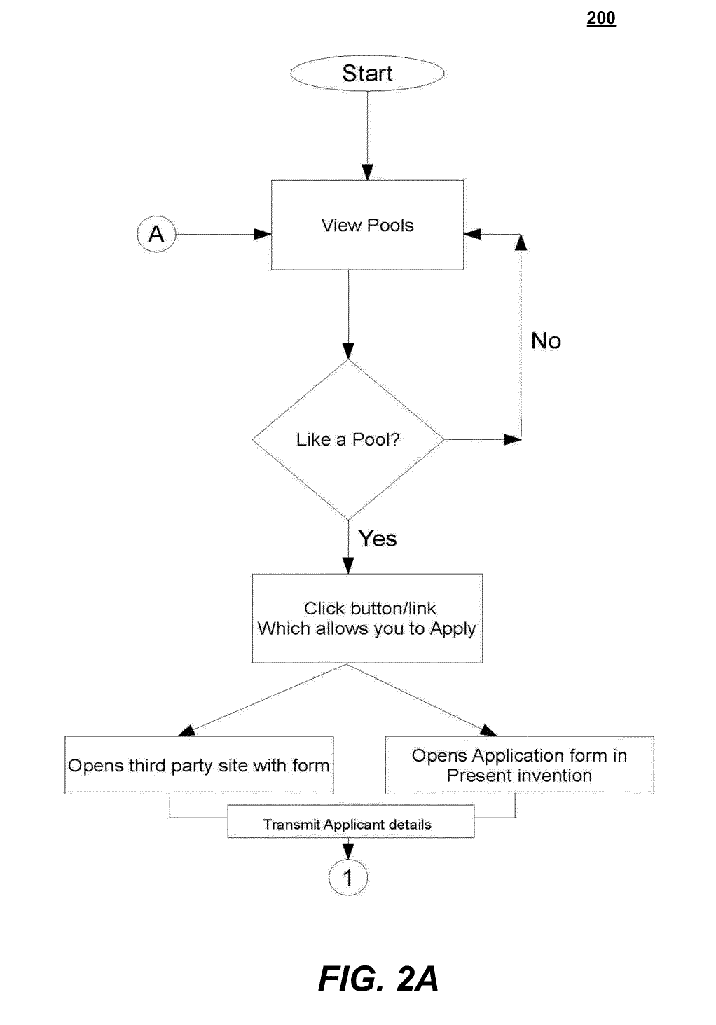

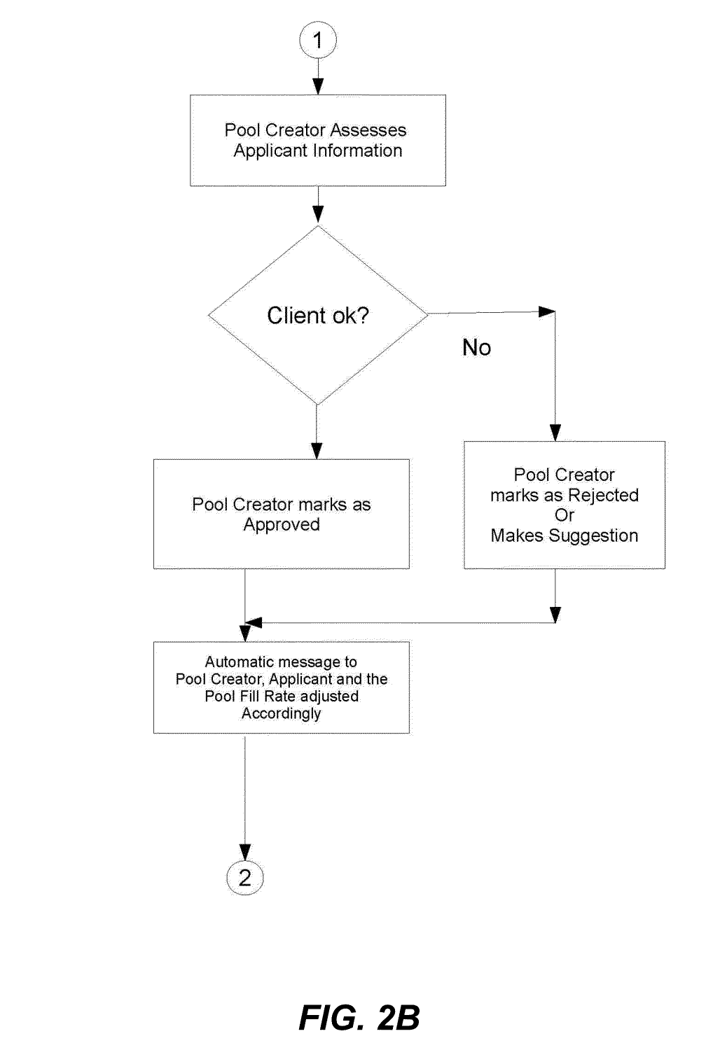

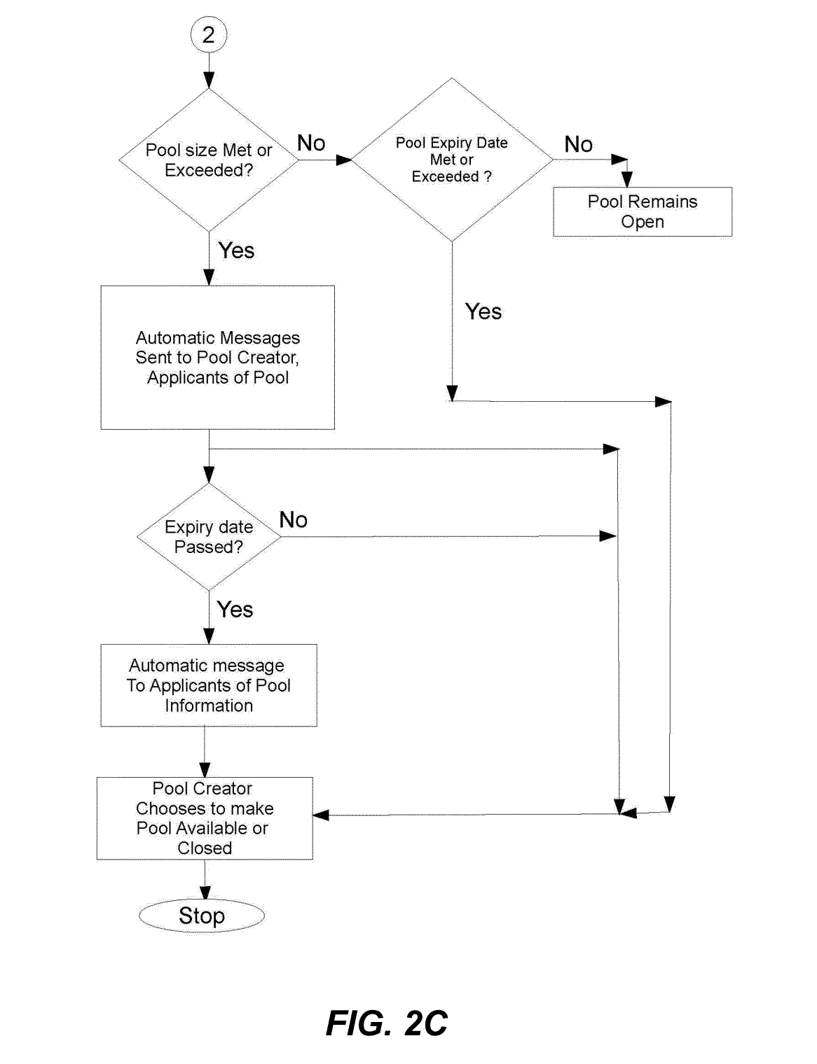

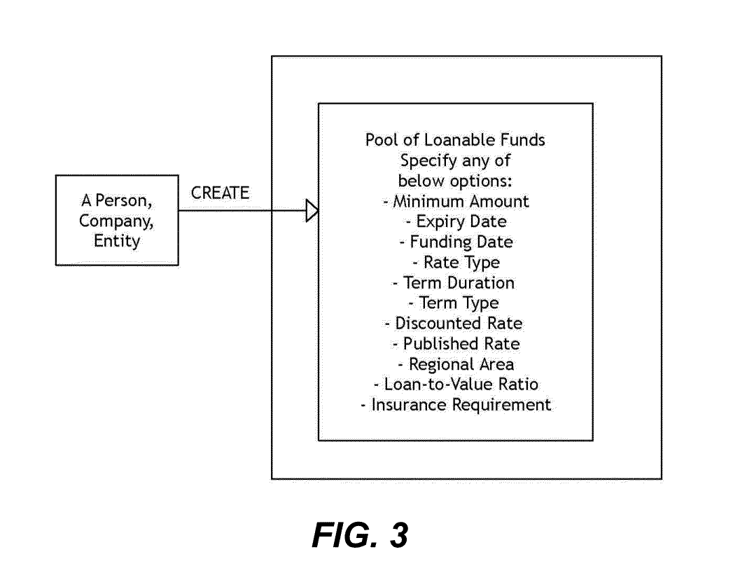

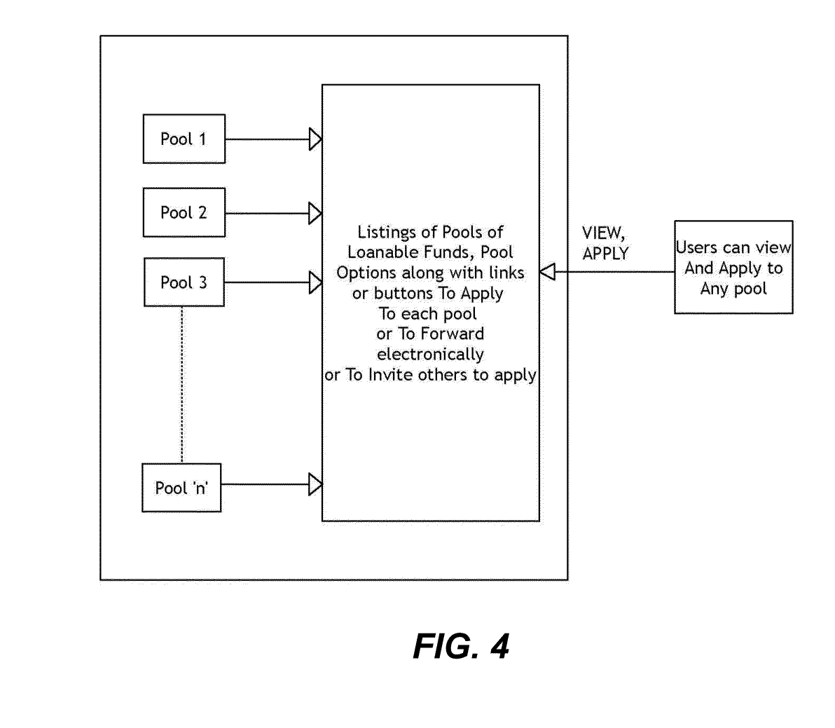

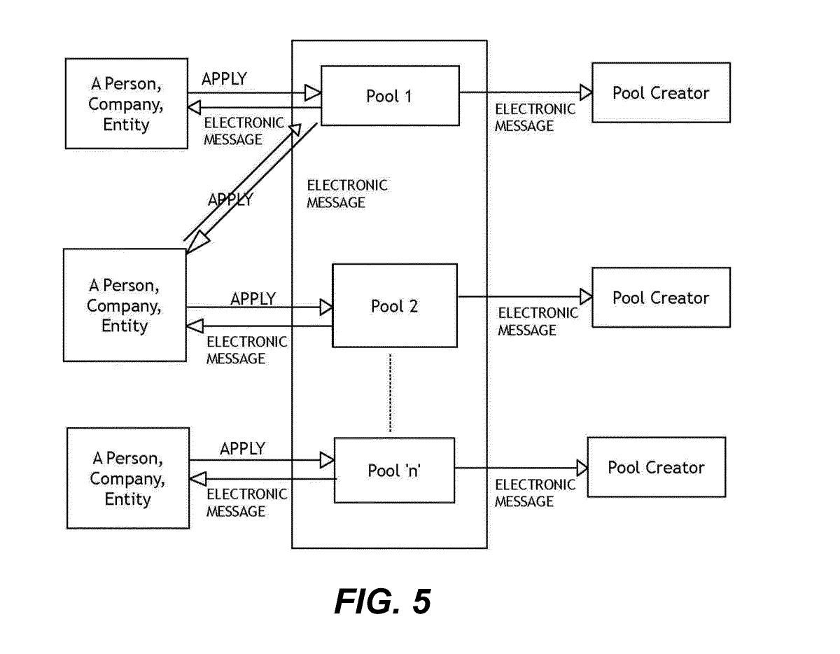

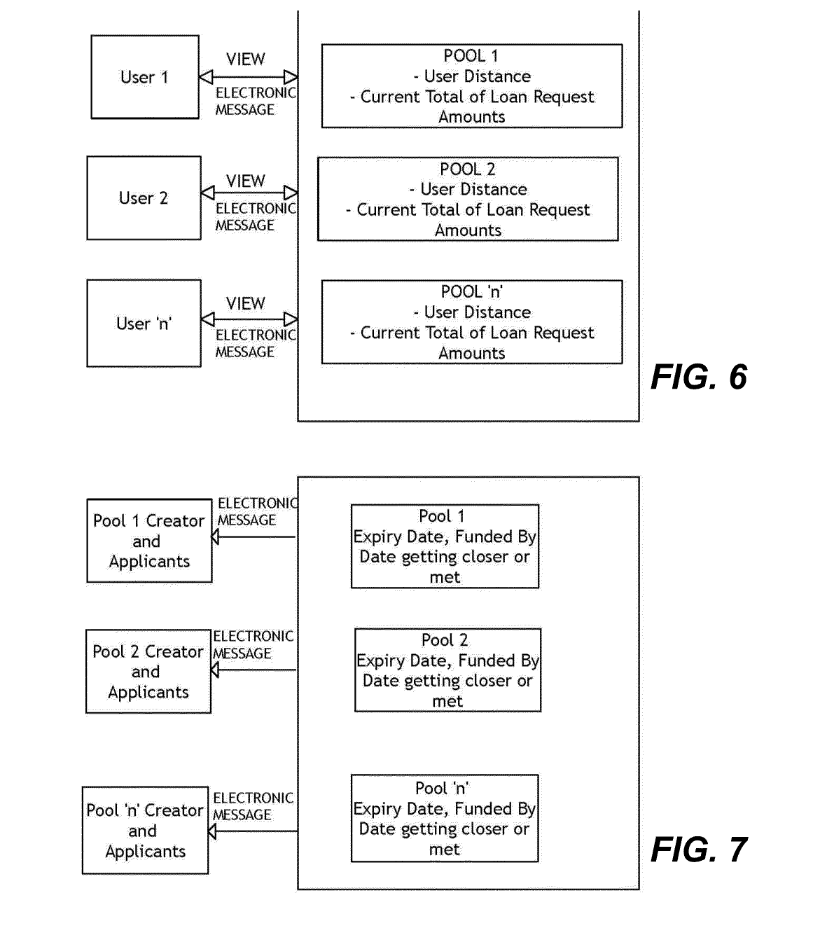

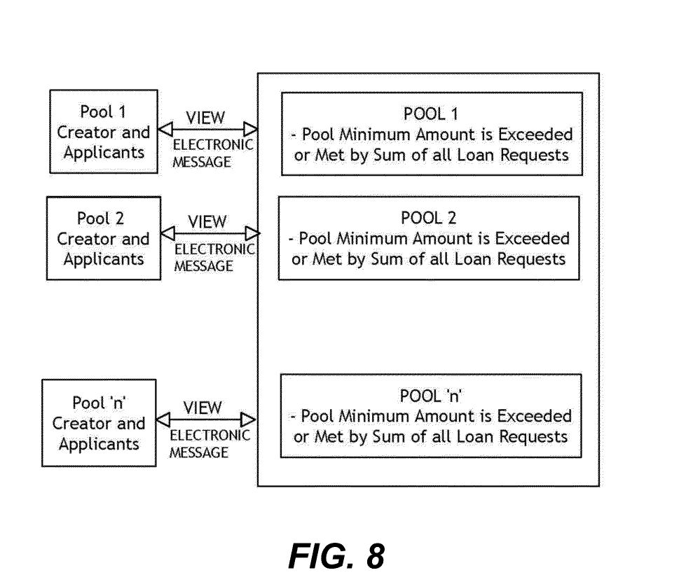

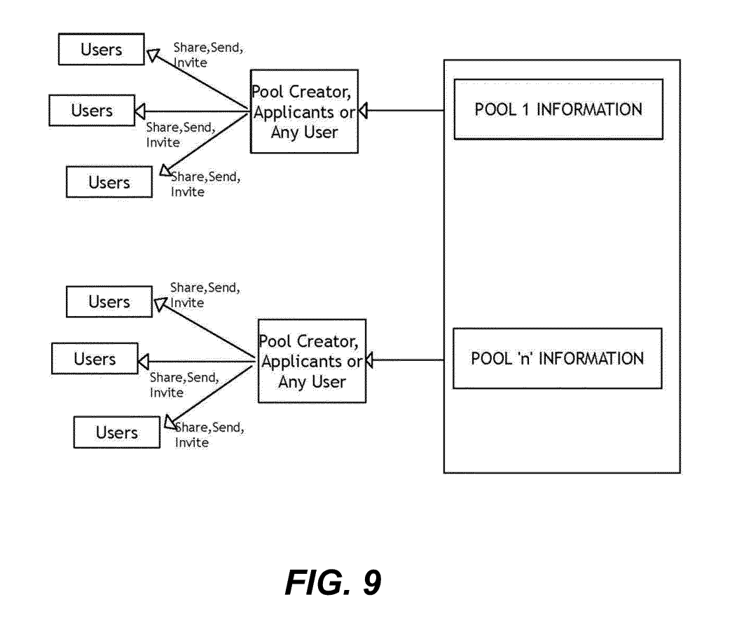

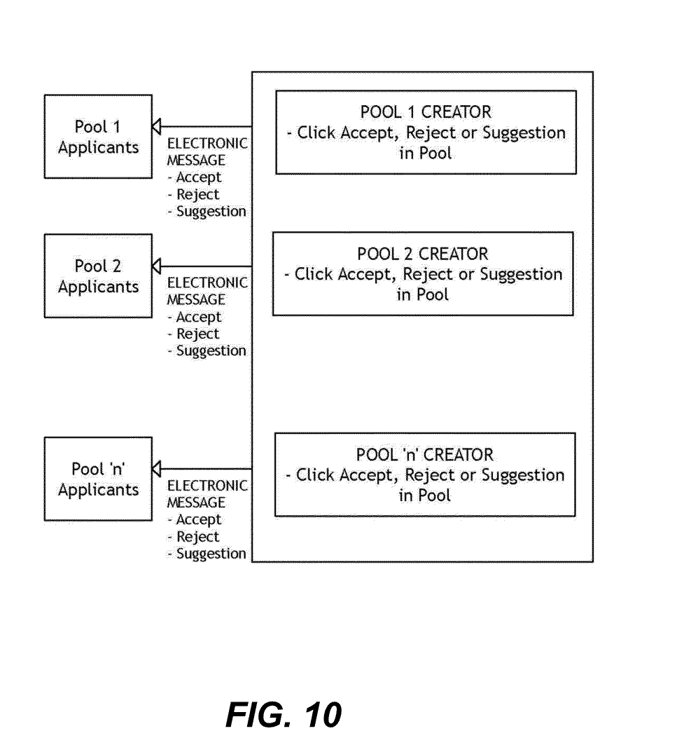

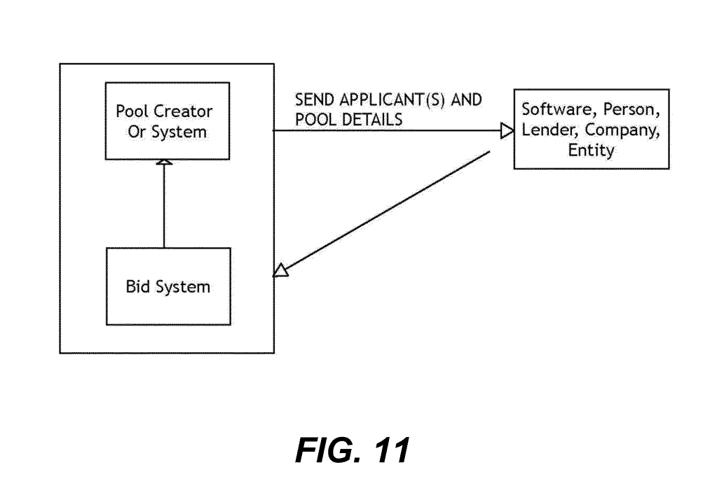

### DETAILED DESCRIPTION

Methods, computer program products, and systems for aggregating loan applicants into groups for group-based financing are disclosed.

Referring to the invention in detail and with reference to accompanying figures, the system allows for the creation of a pool or amount of money or amount of loanable funds over a desktop computer, web, mobile or tablets by a person, a group of persons, a company, a lender or entity.

The pool or amount of money can be created by any person(s), company(s), third party, or lending entity(s). For example, a loan broker can create and fill a loan pool, and provide the pool to lenders for bidding. The pool or amount of loanable funds can be given a combination of or all of the characteristics or attributes such as, but not restricted to, Minimum Amount, Expiry Date, Funded By Date, Rate Type, Term Duration, Term Type, Discounted or Preferred Rate, Published Rate, Regional Area, Loan-to-Value Ratio, Insurance Requirement, and Credit Score.

Minimum Amount is the amount of money, in any currency, that is the minimum that is on offer to applicants before an Expiry Date. Expiry Date is the date by which the sum total of all applicant loan(s) request amounts, in any currency, should meet or exceed the Minimum Amount of the pool of money on offer or as defined and expressed by the creator of the pool. Funded By Date is the date by which each applicant has to receive the money from the lender or creditor or as defined and expressed by the creator of the pool.

Discounted or Preferred Rate is the rate that is offered to the applicants that is valid based on the various combination of the above attributes that are on offer and form the characteristics of the pool. It may be expressed in % or basis points. The Discounted or Preferred Rate may also be expressed in terms of its relation to current Prime Rates. E.g. Prime—0.5%, Prime—50 basis points or any combination of the word ‘Prime’ with the normal method of expressing rates to the public. The Rate can also be expressed conforming to a brand name of a company or as defined and expressed by the creator of the pool.

Published Rate is the rate that is normally offered to applicants who may or may not be applying for this pool or collection of money and may or may not be publicly available or expressed to the applicants from other sources of information. It may be expressed in % or basis points or using the word ‘Prime’. Rate Type is the type of rate that can be used by a lender in order to indicate which type of loan it is and can be Fixed or Variable or a combination of the different types available in the market. E.g. Variable or Adjustable Rate Mortgage (ARM)—⅓ ARM, ⅕ ARM and Fixed etc.

Term Duration is the time for which the rate is offered for a particular pool of loanable funds (e.g., months or years). Term Type is the type of loan term the pool on offer is. This may have values of ‘Closed’, ‘Open’ or a combination thereof or as expressed by person, company or entity creating the pool or collection. Regional Area is an area that may be chosen by the creator of the pool. The Regional Area may be expressed as a zip code or postal code, city, province or any geographical area that can be considered appropriate by normal public understanding. The Regional Area may also be expressed in terms of distances such as using meters, kilometers and miles. Loan-to-Value Ratio is the size of the loan compared to the value of a purchase need. Insurance Requirement may indicate if any insurance is required on the loan request. Credit Score (e.g., FICO score) is a score as currently provided by relevant credit rating agencies.

In some embodiments, a web site or other electronic medium can show a listing of individual pools of money that have been created. Each pool can be shown along with a link or button that allows for a person, group of persons or entity to apply to that pool of money. Each pool may also show any number of links or buttons which allow anyone to forward, tag, email or otherwise message the pool information to anyone else through any electronic messaging, or social networking methods. The listings can be shown over a desktop computer, any web interface, mobile phones and tablet computers. The listings can also be shown on maps and can indicate distances between the creation location of a pool and an applicant's current or permanent location on a map.

In one embodiment, loan pools are displayed geographically. Mapping can be absolute, or relative to a current or permanent location of an applicant. For example, a GPS system can provide real-time, location adjusted mortgage loan pools for a house for sale, while an applicant is viewing the house.

Clicking the link or button to apply to a pool of money may show an Application form with fields that may be filled by the applicant. This form may or may not be provided by the creator of the pool. The form also shows a button or link that can enable the data in the form to be submitted to the present invention or may take the applicant to a third party site for further processing.

In some embodiments, the system can collect, store, process, aggregate or forward the information on the form along with the characteristics of the pool to the creator of the pool as well as to the applicant.

E-mail, SMS, or other electronic messages can be sent to the applicant as well as the creator of the pool informing them there is an applicant to the pool along with the details filled in the form by the applicant.

The current total sum of loan or credit requests from all applicants can be shown for each of the pools listed thus allowing anyone to view the current fill rate and allow them to visually track and know the current total loan request amounts that are filling each pool.

E-mail, SMS, or other electronic messages can be sent to an applicant as any the attributes, such as Expiry Date, Funded By Date get closer, are met, or if the fill rate is approaching a limit, and the like.

Furthermore, e-mail, SMS or other electronic messages can be sent to the applicants and the creator of the pool when the Minimum Amount of the pool is equaled or exceeded by the total sum of all applicants' loan request amounts which are entered by or calculated or inferred from the applicants as they submit their individual applications to a particular pool.

The system may also allow potential applicants to enter contact details data and express interest in being informed of pools according to a combination of attributes that may interest them when such pools get created in the present invention.

The system may also allow a creator or applicant to share the pool information with other people and invite other people to join in the pool. For example, social networking tools such as friend lists or followers can be utilized for this purpose.

The creator of the pool can accept, reject or make a suggestion to each applicant in a pool. This acceptance or rejection or suggestion to an applicant can be done using computer software or manually over a desktop computer, web, mobile or tablet computer. The acceptance, rejection or suggestion may also be emailed or electronically messaged to an applicant in a pool through the present invention.

The system may also allow a creator of a pool or the present invention itself to electronically transmit or forward a pool or a combination of pools with their data attributes and applicants' information, data and characteristics to computer software, lenders, persons, companies or entities. The pool may be forwarded based on bids received for the pool by prospective lenders.

The advantages of the invention include, without limitation, that a person, lender, company or any entity can, using desktop, web, mobile or tablet computers, create a pool of loanable funds that can be offered with a set of attributes including but not limited to Minimum Amount, Expiry Date, Funded By Date, Closing Date, Rate Type, Term Duration, Term Type, Discounted or Preferred Rate, Published Rate, Regional Area, Loan-to-Value Ratio, Insurance Requirement, Credit Score or other characteristics that may be considered important by the creator of the pool.

The pools of loanable funds on offer help to make current loan rates offered to applicants customizable by grouping or aggregating the applicants based on their preferred requirements of above mentioned attributes and by removing the need for intermediaries offered broker commissions to get loan applicants for lenders.

In an embodiment, applicants may also be permitted to indicate one or more from a list of banking or lending services they may currently want to switch from at their current lender or banker or financial company to the creator of the loan pool in order to qualify for a discounted rate. This list can be one or more of the many public services offered by a bank or lender or financial institution and provides a switching incentive for the loan pool creator to offer discounted rates.

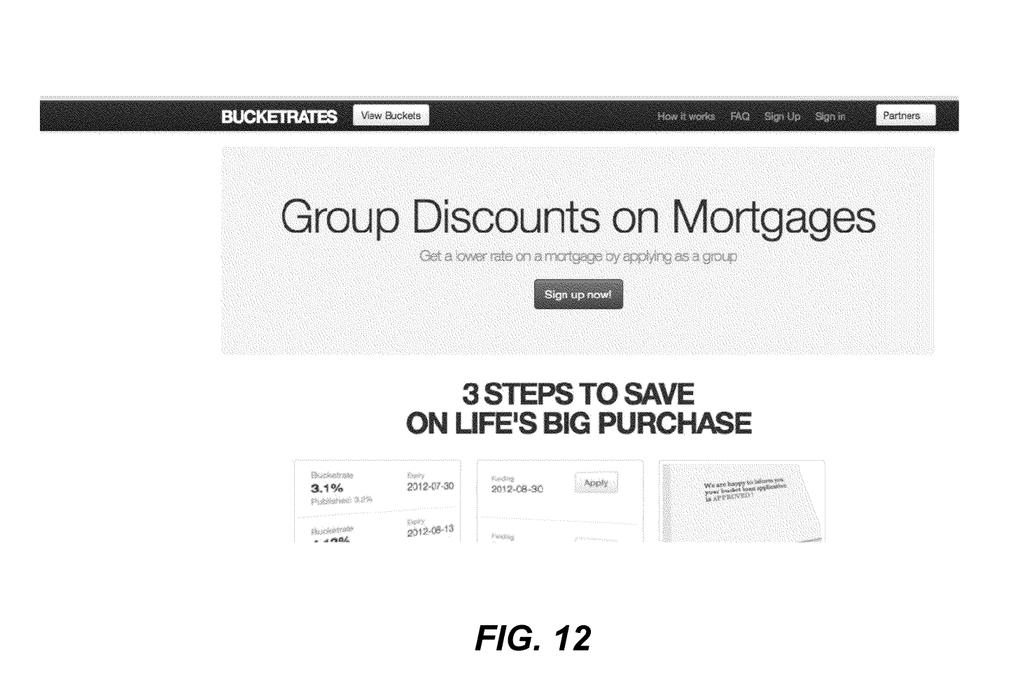

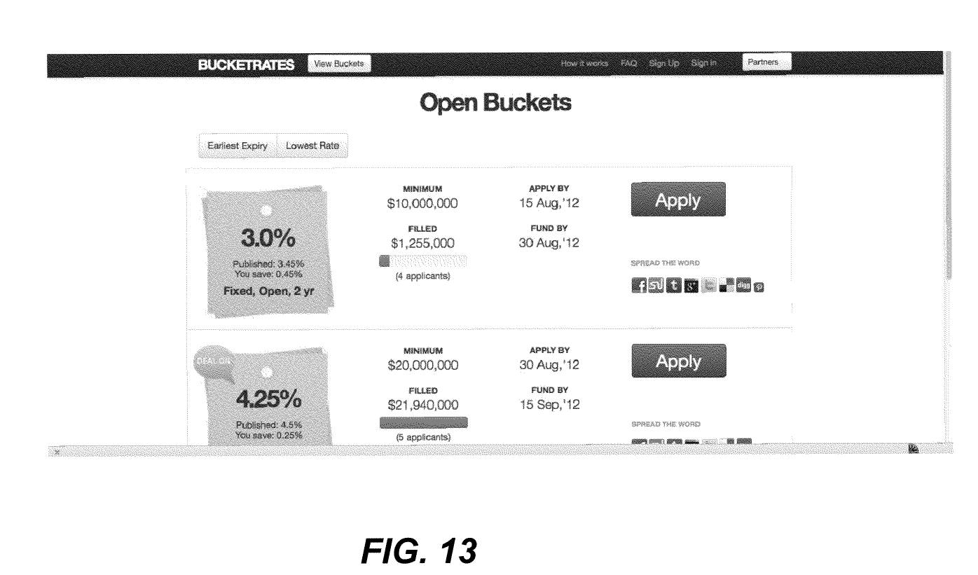

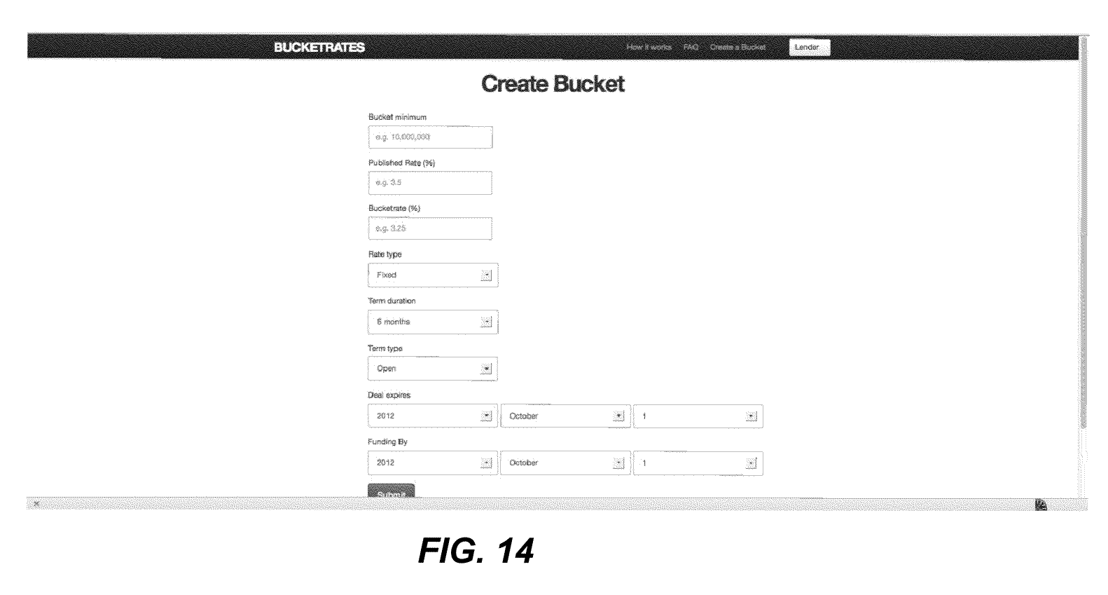

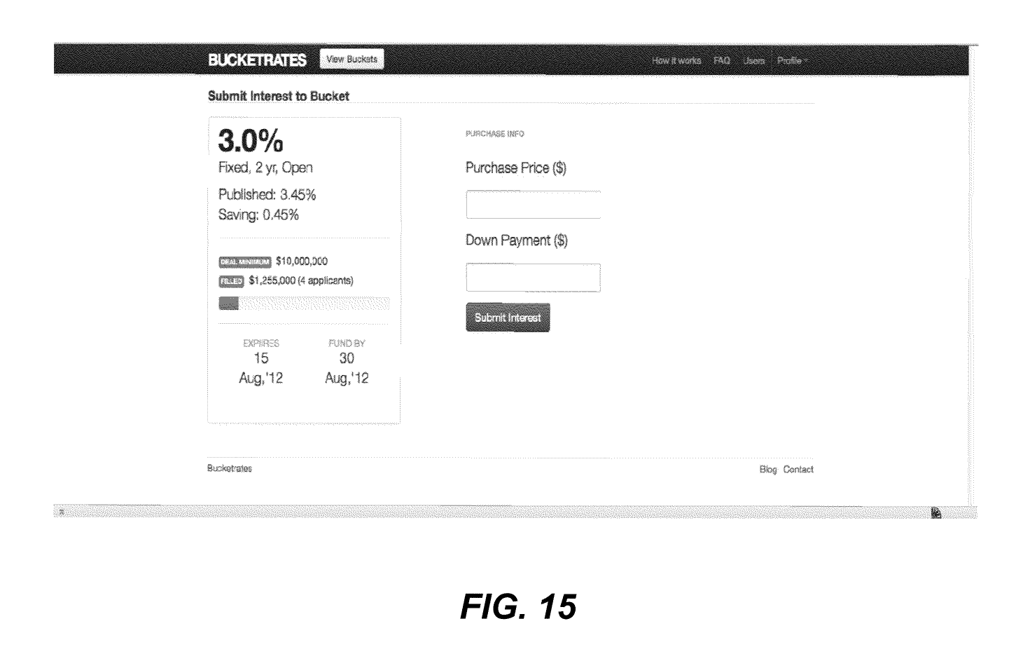

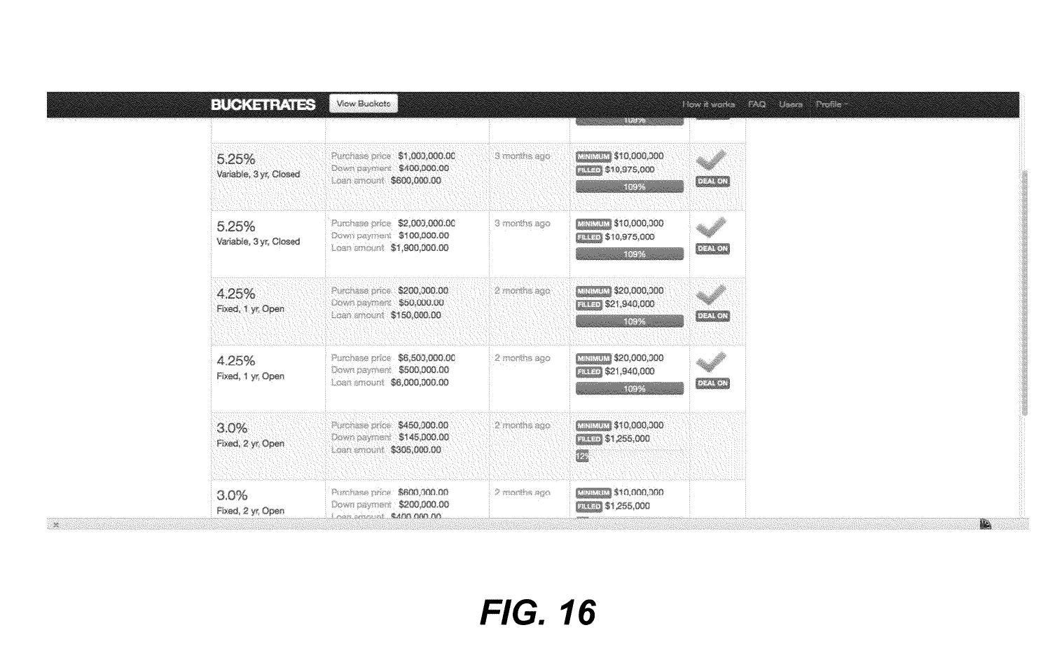

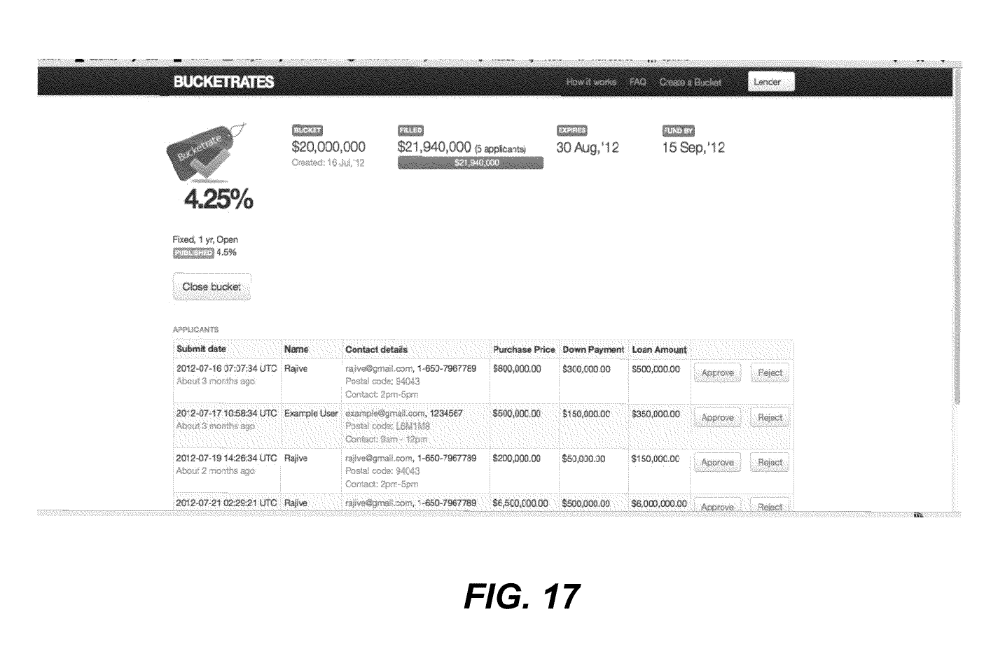

Generally, the system can include a bucket rate server, a lender server, and an applicant device. Each of the system components can be implemented by a personal computer, a laptop, a tablet, a smart phone, or other processor-based device (including, for example, a processor, a memory, a hard drive, and input/output devices) and are connected to a network (e.g., Internet, WAN, LAN). The bucket rate server can host a web site with individual web pages, such as those shown in FIGS. 12-17.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We Claim:

1. A computer-implemented method for aggregating loan applications, comprising:
creating at least one loan pool to provide financing for purchases;
assigning characteristics to each of the at least one loan pool;
prequalifying one or more submitted applications to at least one of the at least one loan pool; and
closing the at least one loan pool upon reaching a threshold characteristic.

2. The method of claim 1, wherein the characteristics comprise one or more of: Minimum Amount, Expiry Date, Funded By Date, Closing Date, Rate Type, Term Duration, Term Type, Discounted or Preferred Rate, Published Rate, Regional Area, Loan-to-Value Ratio, Insurance Requirement, and Credit Score.

3. The method of claim 1, wherein the at least one loan pool is created by at least one of: a lender, a group of lenders, a company, a loan applicant, a group of loan applicants, and a third-party.

4. The method of claim 1, further comprising:
inviting additional applicants to join the at least one loan pool.

5. The method of claim 1, further comprising:
sending messages to applicants responsive to a change in status of corresponding loan applications of the at least one loan pool.

6. The method of claim 1, further comprising:
sending a message to a lender associated with the at least one loan pool responsive to change in status of the at least one loan pool.

7. The method of claim 1, wherein the threshold condition comprises at least one of the following being met: Expiry Date, Funded by Date, Maximum Number of Applicants, or Current Total of Loan Request Amounts.

8. The method of claim 1, further comprising:
displaying a geographical mapping one more of least one loan pool.

9. The method of claim 1, further comprising:
displaying a geographical mapping of the at least one loan pool relative to a current or permanent location of an applicant.

10. The method of claim 1, further comprising:
receiving a bid for the at least one loan pool from a lender.

11. The method of claim 1, wherein applicants may also be permitted to indicate one or more from a list of banking or lending services they may currently want to switch from at their current lender or banker or financial company to the creator of the loan pool in order to qualify for a discounted rate.
